(19) United States
(12) Patent Application Publication
(10) Pub. No.: US 2002/0197983 A1
(43) Pub. Date: Dec. 26, 2002

(54) Terminal function setting method, terminal function setting system, terminal, and program

(76) Inventors: Oliver Chubb, San Francisco, CA (US); Koki Mishima, Tokyo (JP)

Correspondence Address: Kit M. Stetina, STETINA BRUNDA GARRED & BRUCKER, 75 Enterprise, Suite 250, Aliso Viejo, CA, 92656, US

(21) Appl. No.: 10/120,182

(22) Filed: Apr. 10, 2002

(30) Foreign Application Priority Data
Jun. 26, 2001 (JP) 2001-193030

(51) Int. Cl. H04M 3/00

(52) U.S. Cl. 455/418; 455/566

(57) ABSTRACT

A method for setting a menu shown on a display of a terminal in accordance with the interest of a user. In the method, the terminal sends a transmission request for menu information to a setting system. The menu information, which is stored in the setting system, is used to set a graphical user interface that is included in the menu. The setting system retrieves the menu information in response to the transmission request for the menu information. The setting system transmits the retrieved menu information to the terminal. The terminal uses the received menu information to change the setting of the menu.

### BACKGROUND OF THE INVENTION

The present invention relates to a method for setting a graphical user interface of a menu shown on a terminal and to a system, terminal, and program for setting a graphical user interface.

In the prior art, when the power of a cellular phone is turned on, a menu is shown on a display of the cellular phone. The menu is incorporated in the cellular phone when the phone is manufactured. A multiple number of menus are incorporated in the cellular phone so that they can be selected in accordance with the interests of a user. The user selects and sets a menu from the multiple screens.

However, menus incorporated in the cellular phone have limited designs and functions. Thus, the incorporated menus may not satisfy the user's needs. To satisfy the user's needs, the user would have to be able to set a menu in accordance with his or her interests. Further, the applications performed on a cellular phone by a user differ between individuals. Since the incorporation of menus when the cellular phone is manufactured limits the functions of the menus, the user may have to carry out many manipulations to perform a certain application, even if the application is a frequently used one.

### SUMMARY OF THE INVENTION

It is an object of the present invention to provide a method for setting a graphical user interface of a menu, which is shown on a terminal, in accordance with every individual user's interests. It is a further object of the present invention to provide a system, terminal, and program for setting a graphical user interface in accordance with every individual user's interests.

To achieve the above object, the present invention provides a method for setting a function in a terminal having a display that shows a menu. The terminal is connected to a terminal function setting system through a network. The setting system includes a menu information memory. The method includes storing menu information in the menu information memory. The menu information is used to set a graphical user interface that is included in the menu. The method further includes receiving a transmission request for the menu information from the terminal with the setting system, retrieving the menu information from the menu information memory in response to the transmission request for the menu information, and transmitting the retrieved menu information from the setting system to the terminal.

A further perspective of the present invention is a method for changing a menu shown on a display of a terminal. The terminal is connected to a terminal function setting system through a network. The setting system includes changing information that is used to change the menu. The method includes receiving a changing request from the terminal with the terminal function setting system to change the menu, transmitting the changing information from the terminal setting system to the terminal in response to the received changing request, and changing the menu of the terminal using the transmitted changing information.

A further perspective of the present invention is a system for setting a predetermined function to a terminal, which has a display that shows a menu, through a network. The terminal function setting system includes a menu information memory for storing menu information used to set a graphical user interface that is included in the menu, a first receiving means for receiving a transmission request for the menu information from the terminal, a first retrieving means for retrieving the menu information from the menu information memory in response to the transmission request for the menu information, and a first transmitting means for transmitting the retrieved menu information to the terminal.

A further perspective of the present invention is a terminal connected to a setting system through a network and having a display that shows a menu. The terminal includes a first downloading means for downloading menu information from the setting system to set a graphical user interface that is included in the menu, and a first setting means for setting the graphical user interface using the downloaded menu information.

A further perspective of the present invention is a program for operating a terminal. The terminal is connected to a setting system through a network and has a display for showing a menu. The program includes downloading menu information from the setting system to set a graphical user interface that is included in the menu, and setting the graphical user interface using the downloaded menu information.

A further perspective of the present invention is a program for operating a terminal and downloaded to the terminal from a setting system through a network. The terminal is connected to the setting system through the network and has a display for showing a menu. The program includes downloading menu information from the setting system to set a graphical user interface that is included in the menu, setting the graphical user interface using the downloaded menu information, downloading component information from the setting system to set an additional function to the graphical user interface, and setting the additional function to the graphical user interface using the downloaded component information.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram illustrating a setting system according to a preferred embodiment of the present invention;

FIG. 2 is an explanatory diagram illustrating the data stored in a menu information memory of the setting system of FIG. 1;

FIG. 3 is an explanatory diagram illustrating the data stored in a component information memory of the setting system of FIG. 1;

FIG. 4 is an explanatory diagram illustrating a menu shown on a display of a prior art cellular phone;

FIG. 5 is an explanatory diagram illustrating a menu shown on a display of a cellular phone according to the preferred embodiment of the present invention;

FIG. 6 is an explanatory diagram illustrating a further menu shown on the display of the cellular phone according to the preferred embodiment of the present invention;

FIG. 7 is an explanatory diagram illustrating a further menu shown on the display of the cellular phone according to the preferred embodiment of the present invention;

FIG. 8 is a flowchart illustrating the procedures performed according to the preferred embodiment of the present invention; and

FIG. 9 is an explanatory diagram illustrating a further menu shown on the display of the cellular phone according to the preferred embodiment of the present invention.

### DETAILED DESCRIPTION OF THE PREFERRED EMBODIMENTS

In the drawings, like numerals are use d for like elements throughout.

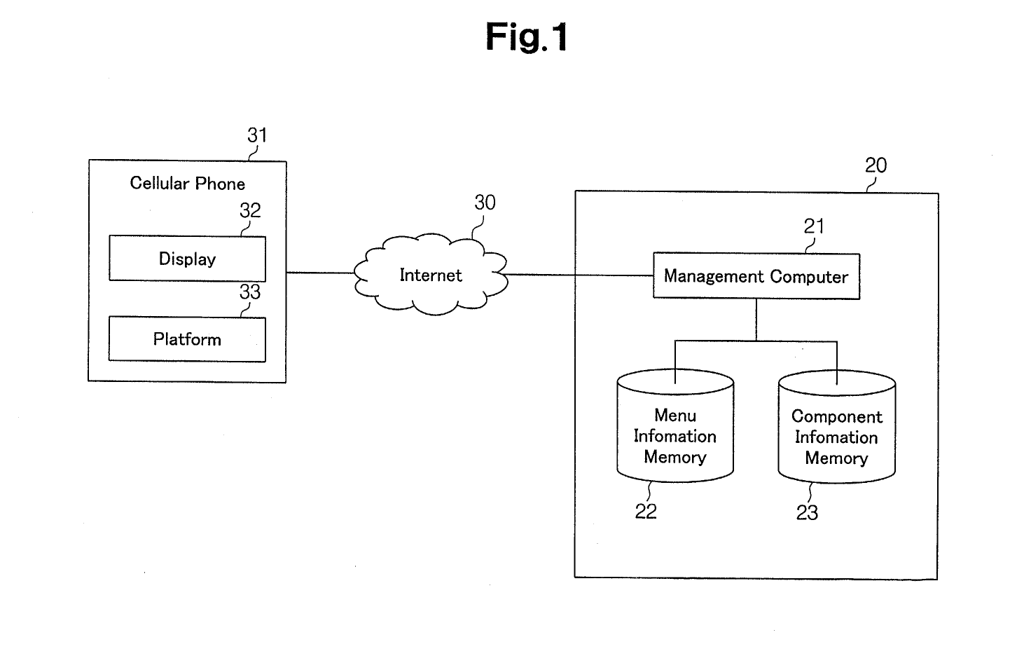

FIG. 1 is a schematic block diagram illustrating a terminal function setting system according to a preferred embodiment of the present invention. In the preferred embodiment, the terminal function setting system is applied to a server 20, which provides menus of a cellular phone.

As shown in FIG. 1, a cellular phone (terminal) 31 is connected to the menu providing server 20 through the Internet 30.

The cellular phone 31 has a display 32. When the power of the cellular phone 31 is turned on, a menu is shown on the display 32. The menu is incorporated in the cellular phone 31 when the phone 31 is manufactured.

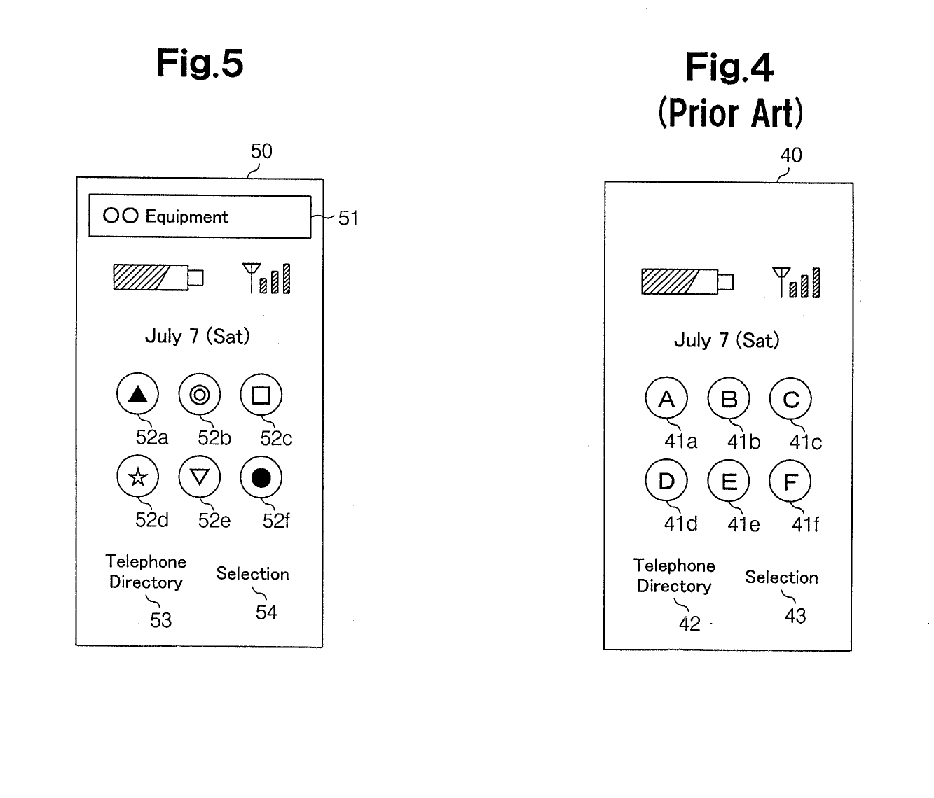

FIG. 4 shows an example of a menu 40 incorporated in a prior art cellular phone 31. The menu 40, which is a graphical user interface, includes function selection keys 41a-41f, a telephone directory key 42, and a function selection key 43.

As shown in FIG. 1, the cellular phone 31 includes a platform 33. The platform 33 downloads files, which include menus or information for adding functions to the menus, from the server 20. The platform 33 uses the downloaded files to change the system of the cellular phone 31 and change the setting of the menu 40. The platform 33 includes a menu information downloading means, a menu information setting means, a component information downloading means, and an additional function setting means.

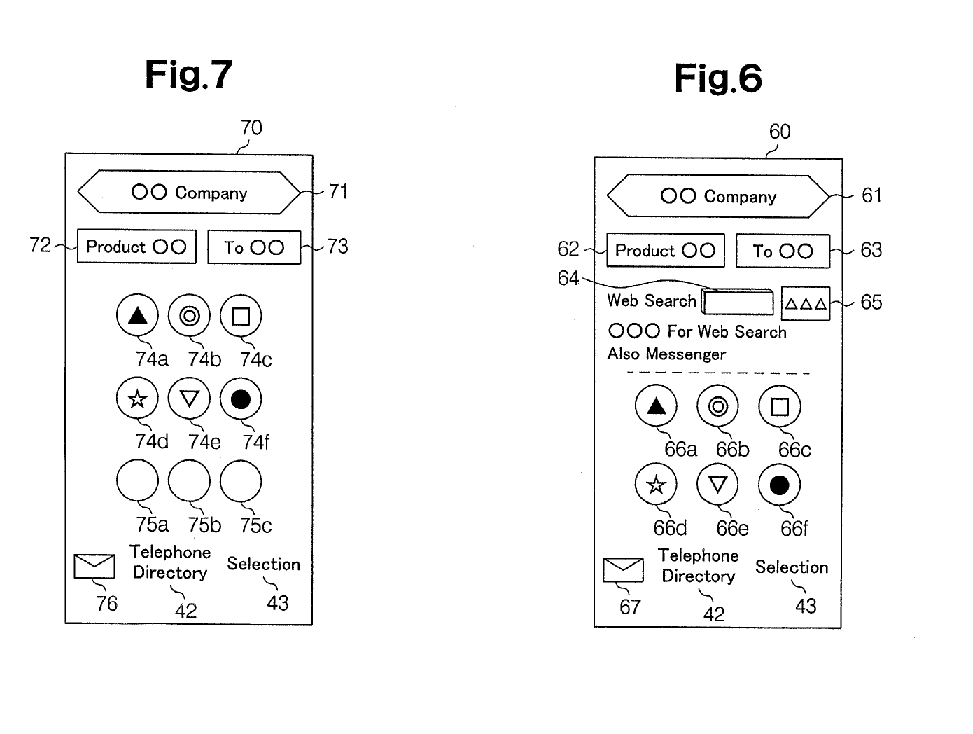

FIG. 5 shows a menu 50, which is obtained by changing the design of the original, incorporated menu 40. FIG. 6 shows a menu 60, which is obtained by adding predetermined functions to the incorporated menu 40. FIG. 7 shows a menu 70 that enables the setting of additional functions.

More specifically, in the menu 50, an advertisement 51 of a company, which runs the server 20 (FIG. 1), is shown at the upper portion. The lower portion of the menu 50 is designed with colors (e.g., green) differing from those used in the incorporated menu 40. For example, function selection keys 52a-52f, a telephone directory key 53, and a function selection key 54, which define an operation panel, are designed with patterns and colors (e.g., deep green) that differ from those of the incorporated menu. Further, portions other than the operation panel are designed with a color (e.g., green) differing from that of the incorporated menu. The function selection keys 52a-52f, the telephone directory key 53,and the function selection key 54 have the same functions as those incorporated in the cellular phone 31.

In the menu 60, an advertisement 61 of a company sponsoring the menu 60 is shown at the upper portion. Under the advertisement 61, the menu 60 has shortcuts 62, 63, which are used to proceed to a product introduction screen, a search engine window 64, and a shortcut 65, which is used to proceed to a company introduction screen, are shown. Under the shortcut 65, the menu 60 has function selection keys 66a-66f, an e-mail key 67, a telephone directory key 68, and a function selection key 69.

A user uses the shortcuts 62, 63, 65, the search engine window 64, or the e-mail key 67 to perform the functions added to the incorporated menu 40. Each of the shortcuts 62, 63, 65 has a uniform resource locator (URL). When the shortcuts 62, 63, 65 are selected, the cellular phone 31 is linked to an associated website to show a product or company introduction page in the menu 60. The search engine window 64 is used to conduct a search with a search engine. When the e-mail key 67 is selected, e-mail-related functions may be used.

In the menu 70, a company advertisement 71, shortcuts 72, 73, function selection keys 74a-74f, user setting icons 75a-75c, an e-mail key 76, a telephone directory key 77, and a function selection key 78 are shown.

The cellular phone 31 includes a browser. The browser, which is an application program used to read hypertext files (Web pages), sends a request for transmission of a Web page, which is identified by a URL, to the server 20.

Referring to FIG. 1, the server 20 includes a management computer 21, a menu information memory 22, and a component information memory 23. The management computer 21, which includes a CPU, a RAM, and a ROM (none shown), executes programs, manages data, and controls the transfer of data. In the preferred embodiment, the management computer 21 includes a menu transfer requesting means, a menu information retrieving means, a menu information transmitting means, a component information transmission request receiving means, a component information retrieving means, and a component information transmitting means.

The ROM (not shown) of the management computer 21 stores a menu setting program and an additional function setting program. The management computer 21 performs the operation of each means in accordance with each program.

When the management computer 21 receives a request to download a menu file from, for example, the cellular phone 31, the management computer 21 retrieves the requested menu file and transmits the retrieved menu file to the cellular phone 31 in accordance with a menu setting program. When the management computer 21 receives a request for the transmission of a component file from, for example, the cellular phone 31, the management computer 21 retrieves the requested component file and sends the retrieved component file to the cellular phone 31 in accordance with an additional function setting program. The component file is used to set additional functions to a menu.

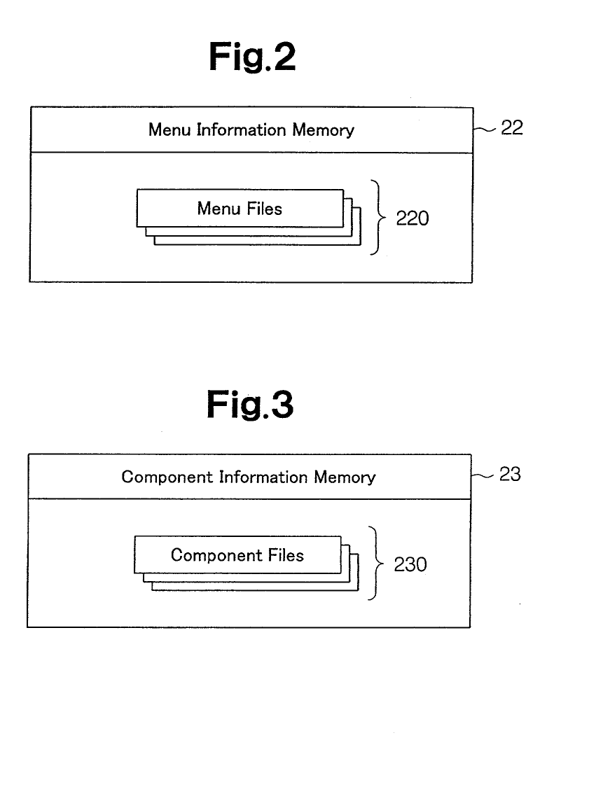

The menu information memory 22 and the component information memory 23 are connected to the management computer 21. Referring to FIG. 2, the menu information memory 22 stores menu files 220. The menu files 220 include information of the menus that appear on the cellular phone 31 when the power of the phone 31 is turned on. A menu is a graphical user interface and includes a shortcut for each function. The menu information memory 22 stores the file of the menu 70 prior to the setting of additional functions by the user (i.e., menu in which the user setting icons 75a-75c are not set) and the files of the menus 50, 60.

The menu files 220 include files produced by the company that manages the server 20, files produced by other companies upon request from the company managing the server, and files solely produced by other companies. The menu information memory 22 stores the menu files 220 prior to the execution of the process of the preferred embodiment.

Referring to FIG. 3, the component information memory 23 stores component files 230. The component files 230 are files used to add predetermined functions to the menus of the menu files 220 (e.g., files for setting the user setting icons 75a-75c).

When the cellular phone 31 enables additional functions to be set to its menu, predetermined functions are added to the menu in accordance with the component files 230. In such a case, the component files 230 are downloaded to the cellular phone. The component files 230, which are produced by the company that manages the server 20 or by other companies, are stored in the component information memory 23 prior to the execution of the process of the preferred embodiment.

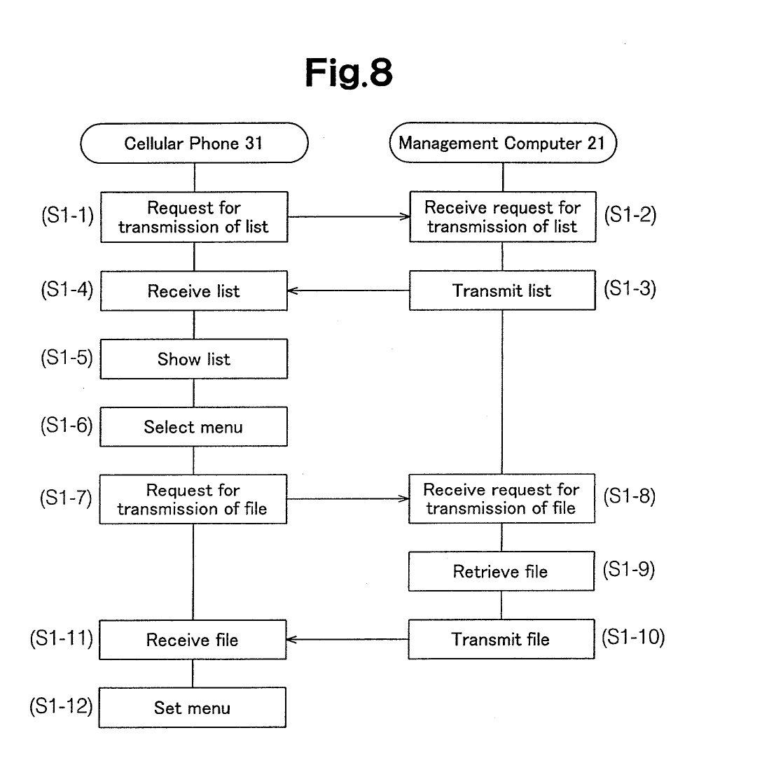

The process executed by the server 20 will now be discussed with reference to FIG. 8. The management computer 21 executes the following process in accordance with the menu setting program.

Referring to FIG. 8, the user of the cellular phone 31 accesses the server 20 from the cellular phone 31 and indicates the type of the cellular phone 31. The cellular phone 31 then transmits a transmission request of a menu list (S1-1).

When the management computer 21 receives the menu list transmission list (S1-2), the management computer 21 retrieves the menu files 220 from the menu information memory 22. The management computer 21 generates a Web page, which shows the menu list, from the retrieved menu files 220 and transmits the Web page to the cellular phone 31 (S1-3). The cellular phone 31 receives the Web page (menu list) (S1-4), and shows the received Web page on the display 32 (S1-5). The user selects the menu that is to be set to the cellular phone 31 from the menu list shown on the display 32. The user selects, for example, the menu 50 or the menu 60.

The user downloads the selected menu file 220 using the platform 33 of the cellular phone 31 and sets the desired menu to the cellular phone 31 with the menu file 220.

To set the menu, a transmission request for the menu file 220 including information of the selected menu is sent from the cellular phone 31 to the server 20 (S1-7). When the management computer 21 receives the transmission request of the menu file 220 (S1-8), the management computer 21 retrieves the menu file 220 of the selected menu from the menu information memory 22 (S1-9).

The management computer 21 sends the retrieved menu file 220 to the cellular phone 31 (S1-10). The cellular phone 31 receives the retrieved menu file 220 (S1-11). The user uses the received menu file 220 to set the menu 50 or the menu 60 in lieu of the incorporated menu 40 in accordance with the platform 33 (S1-12).

When setting the cellular phone 31 with a menu that enables the setting of additional functions, such as the menu 70, the user further sets the additional functions. In such a case, the cellular phone 31 sends a transmission request for the corresponding component file 230, which includes the additional functions, to the management computer 21 when sending the transmission request for the menu file 220 (S1-7). When the management computer 21 receives the transmission request of the component file 230, the management computer 21 retrieves the component file 230 from the component information memory 23 (S1-9). The management computer 21 sends the component file 230 to the cellular phone 31 when sending the menu file 220 (S1-10). The user uses the component file 230 to set the additional functions when setting the menu with the menu file 220 in accordance with the platform 33. For example, in the menu 70, the user setting icons 75a-75c are set using the component file 230.

The menu providing server 20 and the cellular phone 31 of the preferred embodiment has the advantages described below.

The user of the cellular phone 31 may set one of the menus 50, 60, 70, which has a preferable design, and use the same functions as the incorporated menu 40. Since the user may select a menu having a preferable design, the user gets more satisfaction.

The advertisement 61 is shown on the menu 60 of the cellular phone 31. Thus, the menu 60 may be used to advertise a company.

The user of the cellular phone 31 uses the shortcuts 62, 63, 65 to access Web sites. Thus, the company that sets the menu 60 may use the shortcuts 62, 73, 65, which are linked to product introductions, as advertisements.

The user of the cellular phone 31 may set the functions of the user setting icons 75a-75c with the component files 230. This enables the user to set the desired functions in the menu 70.

It should be apparent to those skilled in the art that the present invention may be embodied in many other specific forms without departing from the spirit or scope of the invention. Particularly, it should be understood that the present invention may be embodied in the following forms.

Fees may be charged to download the menu files 220. In this case, registered users may be billed periodically.

In the menu 50, the design of either the operation panel or portions other than the operation panel may be changed. Further, the size or form of the displayed operation panel may be changed.

Fees may be charged to show advertisements on the menus 60, 70. In this case, the advertiser may be billed when the menus 60, 70, which contain the advertisement, are downloaded to the cellular phone 31. For example, the server 20 counts the number of times the menus 220 are downloaded. The company running the server 20 then bills the advertiser in accordance with the number of downloads. This enables the company running the server 20 to bill the advertiser in accordance with the advertising effect of the menu advertisements.

When the shortcuts of the menus 60, 70 are used to proceed to a linked Web page, fees may be charged to the company related to the Web page. In this case, the Web page company may be billed in accordance with the number of times the associated shortcut is used.

Companies sponsoring the menus 60, 70 may provide an incentive to users using the menus 60, 70. This enhances the usage of the menus 60, 70.

When setting the menu 70, the associated menu file 220 may be downloaded. When it becomes necessary, the new functions may be added by downloading the associated component files 230.

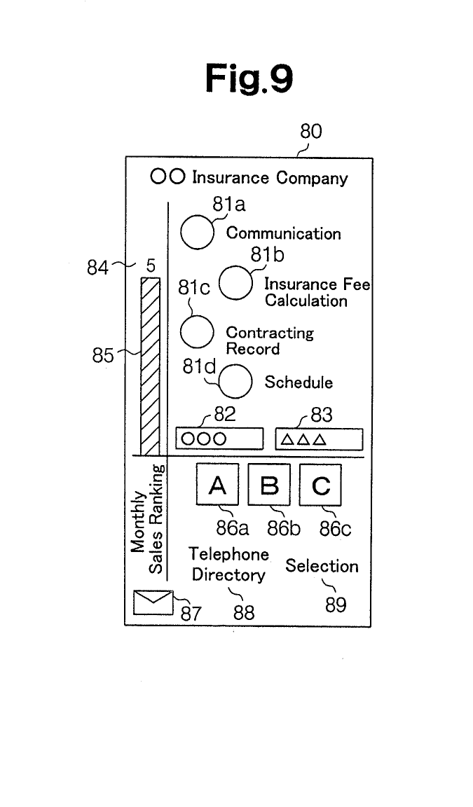

Instead of a general-purpose menu, menus customized for certain companies may be provided. FIG. 9 illustrates an example of a menu 80 customized for a certain insurance company. As shown in FIG. 9, the menu 80 includes customized function icons, shortcuts 82, 83, a sales ranking number 84, a sales record bar 85, function selection keys 86a-86c, an e-mail key 87, a telephone directory key 88, and a function selection key 89. The customized function keys include a communication icon 81a, an insurance fee calculation icon 81b, a contracting record icon 81c, and a schedule icon 81d. The customized function icons 81a-81d, the shortcuts 82, 83, the sales ranking number 84, and the sales record bar 85 are especially customized for the insurance company. The customized function icons 81a-81d, the sales ranking number 84, and the sales record bar 85 may be linked to a database of the insurance company. In this case, the menu is used to show images directly related to tasks performed by an employee of the insurance company. This improves working efficiency in the insurance company.

Files for adding new functions (e.g., games) may be downloaded to the cellular phone 31 with the file of a menu. In this case, the menu has a shortcut for downloading an image to execute the new function. This allows functions further satisfying the demands of a user to be set to the cellular phone 31.

Instead of using the platform 33 of the cellular phone 31, a menu file may be downloaded together with a program for changing the setting of the menu. The program may be downloaded to the cellular phone 31 through the Internet 30.

The menus 50, 60, 70 may be set on a personal handy-phone system (PHS), personal digital assistant (PDA), or other types of terminals.

The cellular phone 31 and the management computer 21 may be connected to each other through an exclusive line, a public line, an intranet, or an extranet (wide area network).

The menu information memory 22 and the component information memory 23 do not have to be arranged in the server 20 and may be located at separate locations.

The present examples and embodiments are to be considered as illustrative and not restrictive, and the invention is not to be limited to the details given herein, but may be modified within the scope and equivalence of the appended claims.

What is claimed is:

1. A method for setting a function in a terminal having a display that shows a menu, wherein the terminal is connected to a terminal function setting system through a network, and the setting system includes a menu information memory, the method comprising the steps of:
storing menu information in the menu information memory, wherein the menu information is used to set a graphical user interface that is included in the menu;
receiving a transmission request for the menu information from the terminal with the setting system;
retrieving the menu information from the menu information memory in response to the transmission request for the menu information; and
transmitting the retrieved menu information from the setting system to the terminal.

2. The method according to claim 1, further comprising the step of:
generating the graphical user interface by changing a design of a graphical user interface that is preset to the terminal.

3. The method according to claim 1, wherein the graphical user interface includes at least one of an advertisement, a shortcut function, and a searching function that uses a search engine.

4. The method according to claim 3, further comprising the step of:.
transmitting information to the terminal to set an additional function to the terminal; and
showing an image on the display to perform the additional function with the shortcut function.

5. The method according to claim 1, wherein the graphical user interface is customized for specific tasks.

6. The method according to claim 1, wherein the setting system includes a component information memory, the method further comprising the steps of:
storing component information for adding an additional function to the terminal in the component information memory;
receiving a transmission request for the component information from the terminal with the setting system;
retrieving the component information from the component information memory in response to the transmission request for the component information;
transmitting the retrieved component information from the setting system to the terminal; and
setting the additional function to the terminal with the graphical user interface.

7. The method according to claim 1, wherein the terminal is a cellular phone, the network is the Internet, and the setting system is a server.

8. A method for changing a menu shown on a display of a terminal, wherein the terminal is connected to a terminal function setting system through a network, the setting system including changing information that is used to change the menu, the method comprising:
receiving a changing request from the terminal with the terminal function setting system to change the menu;
transmitting the changing information from the terminal setting system to the terminal in response to the received changing request; and
changing the menu of the terminal using the transmitted changing information.

9. The method according to claim 8, wherein the terminal is a cellular phone, the network is the Internet, and the terminal function setting system is a server.

10. A system for setting a predetermined function to a terminal, which has a display that shows a menu, through a network, the terminal function setting system comprising:
a menu information memory for storing menu information used to set a graphical user interface that is included in the menu;
a first receiving means for receiving a transmission request for the menu information from the terminal;
a first retrieving means for retrieving the menu information from the menu information memory in response to the transmission request for the menu information; and
a first transmitting means for transmitting the retrieved menu information to the terminal.

11. The system according to claim 10, wherein the graphical user interface is generated by changing a design of a graphical user interface that is preset to the terminal.

12. The system according to claim 10, wherein the graphical user interface includes at least one of an advertisement, a shortcut function, and a searching function that uses a search engine.

13. The system according to claim 12, further comprising:
a new function transmitting means for transmitting information to the terminal to set an additional function to the terminal; and
wherein the shortcut function shows an image on the display to perform the additional function.

14. The system according to claim 10, wherein the graphical user interface is customized for specific tasks.

15. The system according to claim 10, further comprising:
a component information memory for storing component information used to add an addition function to the terminal;
a second receiving means for retrieving a transmission request for the component information from the terminal;
a second retrieving means for retrieving the component information from the component information memory in response to the transmission request for the component information; and
a second transmitting means for transmitting the retrieved component information to the terminal;
wherein the additional function is set to the terminal by the graphical user interface.

16. The method according to claim 10, wherein the terminal function setting system is a server.

17. A terminal connected to a setting system through a network and having a display that shows a menu, the terminal comprising:
a first downloading means for downloading menu information from the setting system to set a graphical user interface that is included in the menu; and
a first setting means for setting the graphical user interface using the downloaded menu information.

18. The terminal according to claim 17, further comprising:
a second downloading means for downloading component information from the setting system to set an additional function to the graphical user interface; and
a second setting means for setting the additional function to the graphical user interface using the downloaded component information.

19. The terminal according to claim 17, wherein the terminal is a cellular phone.

20. A program for operating a terminal, wherein the terminal is connected to a setting system through a network and has a display for showing a menu, the program comprising the steps of:
downloading menu information from the setting system to set a graphical user interface that is included in the menu; and
setting the graphical user interface using the downloaded menu information.

21. The program according to claim 20, the program comprising the steps of:
downloading component information from the setting system to set an additional function to the graphical user interface; and
setting the additional function to the graphical user interface using the downloaded component information.

22. A program for operating a terminal and downloaded to the terminal from a setting system through a network, wherein the terminal is connected to the setting system through the network and has a display for showing a menu, the program comprising the steps of:
downloading menu information from the setting system to set a graphical user interface that is included in the menu;
setting the graphical user interface using the downloaded menu information;
downloading component information from the setting system to set an additional function to the graphical user interface; and
setting the additional function to the graphical user interface using the downloaded component information.
